(19) United States
(12) Patent Application Publication
(10) Pub. No.: US 2005/0010452 A1
(43) Pub. Date: Jan. 13, 2005

(54) System and method for processing transaction records suitable for healthcare and other industries

(76) Inventor: William D. Lusen, East Norriton, PA (US)

Correspondence Address: Alexander J. Burke;Intellectual Property Department, 5th Floor, 170 Wood Avenue South, Iselin, NJ, 08830, US

(21) Appl. No.: 10/873,433

(22) Filed: Jun. 22, 2004

Related U.S. Application Data
(60) Provisional application No. 60/483,193, filed on Jun. 27, 2003.
(60) Provisional application No. 60/515,145, filed on Oct. 28, 2003.

(51) Int. Cl. G06F 17/60

(52) U.S. Cl. 705/3

(57) ABSTRACT

The system of the invention includes an interface processor for receiving transaction data in a first data format identifying transactions concerning financial reimbursement claim information communicated between two entities. The system also includes a transformation processor for converting the received transaction identification data from the first data format to a different second more generic, easily processed and readable second data format thereby allowing for customization and extensibility for different users. The system further includes an indexing processor that uses predetermined information concerning the second data format to identify and extract index information from the re-formatted transaction identification data. The index information is used to locate and retrieve the archived transaction data from a data repository included as part of the system upon user request. The system also includes a storage processor for storing records representing the re-formatted transaction identification data and the associated index information in the data repository. A display processor is also included for initiating display of the re-formatted transaction identification information in the second data format in response to a user command.

### CROSS REFERENCE TO RELATED APPLICATIONS

This is a non-provisional application of provisional application Ser. No. 60/438,193 by W. Lusen filed Jun. 27, 2003 and provisional application serial No. 60/515,145 by W. Lusen filed Oct. 28, 2003.

### TECHNICAL FIELD

This invention concerns a system and associated method for transforming transactions from a first data format to a second more generic, easily processed and readable data format thereby allowing for customization and extensibility for different users.

### DESCRIPTION OF RELATED ART

All businesses, and many individual users, have a legal obligation to maintain accurate records of the transactions they undertake. Record maintenance requires that the user retain, for example, copies of orders sent by e-mail, or to print out the web page receipt from a web site purchase. For the user, this is labor intensive and there is no guarantee that any such created records are complete or reliable. Moreover, records may be lost or misplaced over time.

Prior to the enactment of the Health Insurance Portability and Accountability Act of 1996 (“HIPAA”) which established electronic transaction standards and code sets for the health care industry, conventional UB92 forms (i.e., paper claims) were created for billing. One drawback of this approach is that paper claims are easily lost and can be accessed by one person at a time. A further drawback is that paper claims may require duplication which introduces multiple copies that need to remain synchronized for the life of the document. Another drawback is that paper claims were archived into imaging systems as images and not in a more generic format. This is problematic in that the image format does not facilitate later processing and integration into other computer systems such as billing and receivables workflows.

There are no known systems for processing information related to transaction data which overcome the aforementioned drawbacks.

### SUMMARY OF THE INVENTION

The present invention overcomes the above-noted and other deficiencies of the prior art by providing a system and method for transforming transactions from a first data format to a second more generic, easily processed and readable data format thereby allowing for customization and extensibility for different users. In this manner, the present invention addresses the need for an indexed and viewable archive of transaction records which are sent to and received from health care payers and providers or other participants in electronic data exchange.

A system of the invention includes an interface processor for receiving transaction data in a first data format identifying transactions concerning financial reimbursement claim information communicated between two entities. The system also includes a transformation processor for converting the received transaction identification data from the first data format to a different second more generic, easily processed and readable second data format thereby allowing for customization and extensibility for different users. The system of the invention also includes an indexing processor that uses predetermined information concerning the second data format to identify and extract index information from the re-formatted transaction identification data. The index information is used to locate and retrieve the archived transaction data from a data repository included as part of the system upon user request. The system also includes a storage processor for storing records representing the re-formatted transaction identification data and the associated index information in the data repository. A display processor is also included for initiating display of the re-formatted transaction identification information in the second data format in response to a user command.

### BRIEF DESCRIPTION OF THE DRAWINGS

FIG. 1 is a schematic of an exemplary system embodiment;

FIG. 2 shows an overview of operational steps in flow diagram form, of an embodiment of a method for processing transaction records concerning financial reimbursement claim information communicated between two entities;

FIG. 3 is an exemplary listing of an EDI batch claim submitted by a health care provider formatted in accordance with the standard ANSI X12 837 data format;

FIG. 4 is a more readable representation of the exemplary listing of FIG. 3;

FIG. 5 is an illustration of the re-formatted transaction data in the second data format (i.e., the XML data format);

FIG. 6 is an illustration of an exemplary style sheet syntax that may be applied to the re-formatted transaction data of FIG. 5 to create a Hypertext Markup Language (HTML) document for use by a browser;

FIG. 7 is an illustration of a display that results when the style sheet syntax of FIG. 6 is applied to the re-formatted transaction data of FIG. 5;

FIG. 8 is an illustration of another exemplary style sheet syntax that may be applied to the re-formatted transaction data of FIG. 5 to create a Hypertext Markup Language (HTML) document for use by a browser; and

FIG. 9 is an illustration of a display that results when the style sheet syntax of FIG. 8 is applied to the re-formatted transaction data of FIG. 5.

### DETAILED DESCRIPTION OF THE INVENTION

The present invention provides a system and method for transforming standard ANSI ASC X12 healthcare claim transactions to a more generic, easily processed and readable data format (e.g., XML). The transformed claim transactions are indexed and stored (archived) in an electronic data management (EDM) system for viewing, customization and extensibility for different end users.

The system of the invention provides a number of advantages over prior art systems. One advantage of the invention is that by converting the transaction data into a more generic and easily processed data format, indexing and storage of the data in a document management system is facilitated. The re-formatted data format allows a user to construct different data views which are independent of the underlying generic formatted stored data, thus allowing for extensibility and customization as necessary for different users. A related advantage is that the underlying generic formatted stored data is readable through a generic and customizable viewer, such as an XML-based viewer. Another advantage is that reliance upon paper claim transactions is obviated by virtue of archiving the re-formatted transaction data into a document management system in a generic and easily processed format. A further advantage is that by indexing the data prior to storage, the retrieval of a specific transaction group or group of transactions (records) is supported, such as a specific claim or claims. An additional advantage is that a user has the ability to easily view, fax, print, export and otherwise render the data as appropriate. Another advantage is that by integrating the archived re-formatted transaction data into operational systems, such as billing and receivable workflows, rapid execution of supporting processes such as billing secondary payers is facilitated.

The disclosed elements to be described herein may be comprised of hardware portions (e.g., discrete electronic circuitry), software portions (e.g., computer programming), firmware or any combination thereof. The system according to the invention may be implemented on any suitable computer running an operating system such as UNIX, Windows NT, Windows 2000 or Windows 2003, Linux and MVS. Obviously, as technology changes, other computers and/or operating systems may be preferable in the future. The system as disclosed herein can be implemented using commercially available development tools.

The system of the invention is suitable for use with transaction data that conforms to the ANSI ASC X12 standard. The system has particular, but not exclusive, application to a sub-category of ANSI ASC X12 transactions, namely, i.e. ANSI ASC X12 837 healthcare claim transactions. It is in this context that the present invention is described.

As is well known to those skilled in the healthcare industry, in an effort to standardize communication regarding medical claims and remittance data, the American National Standards Institute (ANSI) has generated an ANSI 837 standard for medical claims and an ANSI 835 for remittance data that specifies the format for a variety of message types that contain the various types of information to be exchanged among healthcare provider and payer entities. More detailed information concerning ANSI 835 and 837 may be found on the data interchange standards association web site at http://www.disa.org.

The present invention is described in the non-limiting context of transmitting transaction data from a health care provider to a health care payer, whereby the transaction data conforms to the ANSI ASC X12 837 standard.

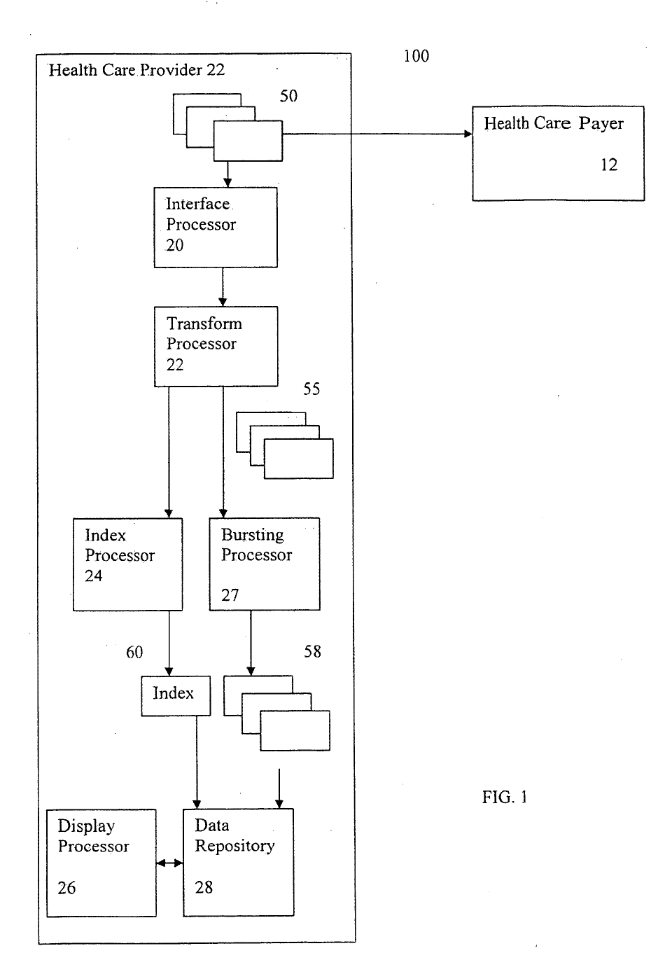

Referring now to FIG. 1, a schematic overview of a system embodiment of the present invention is shown. The elements shown in FIG. 1 may comprise any one or combination of hardware, firmware and/or software. Further, a processor as used herein is a device and/or set of machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. An object as used herein comprises a grouping of data, executable instructions or a combination of both or an executable procedure.

System 100 includes a health care provider 22 in communication with a health care payer 12. The health care provider 22 could represent, for example, a hospital, a hospital department, a physician group a clinic, a healthcare provider institution or a healthcare reimbursement claim payer institution. The health care payer 12 could represent, for example, an insurance company or a Health Maintenance Organization (HMO). The health care provider 22 incorporates the system of the invention which includes an interface processor 20 for receiving information in a first data format identifying transactions concerning financial reimbursement claim information communicated between the health care provider 22 and the health care payer 12; a transformation processor 22 for converting the received transaction identification information from a first data format to a re-formatted second data format 55; an indexing processor 24 that uses predetermined information concerning the second data format (e.g., XML compatible tag identifiers) to identify and extract index information 60 from the re-formatted received transaction identification information 55 in the second data format. The system further includes a bursting processor 27 for bursting the re-formatted received transaction identification information 55 in the second data format into individual patient documents, and a storage processor 29 for for storing the extracted index information 60 along with the individual patient records 58 re-formatted in the second data format in data repository 28. The system also includes a display processor 26 for initiating display of the individual patient records 58 re-formatted in the second data format in response to a user command The afore-mentioned operations are described in greater detail as follows.

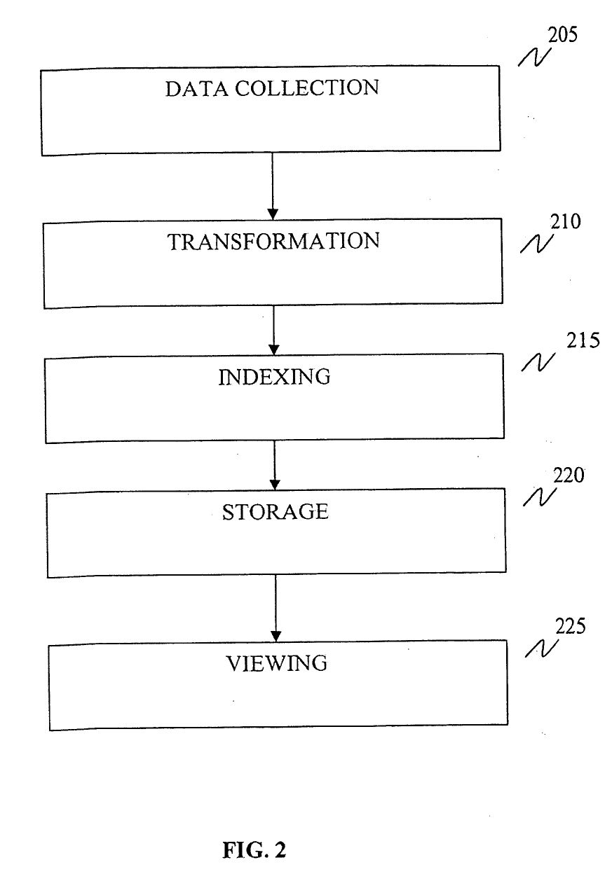

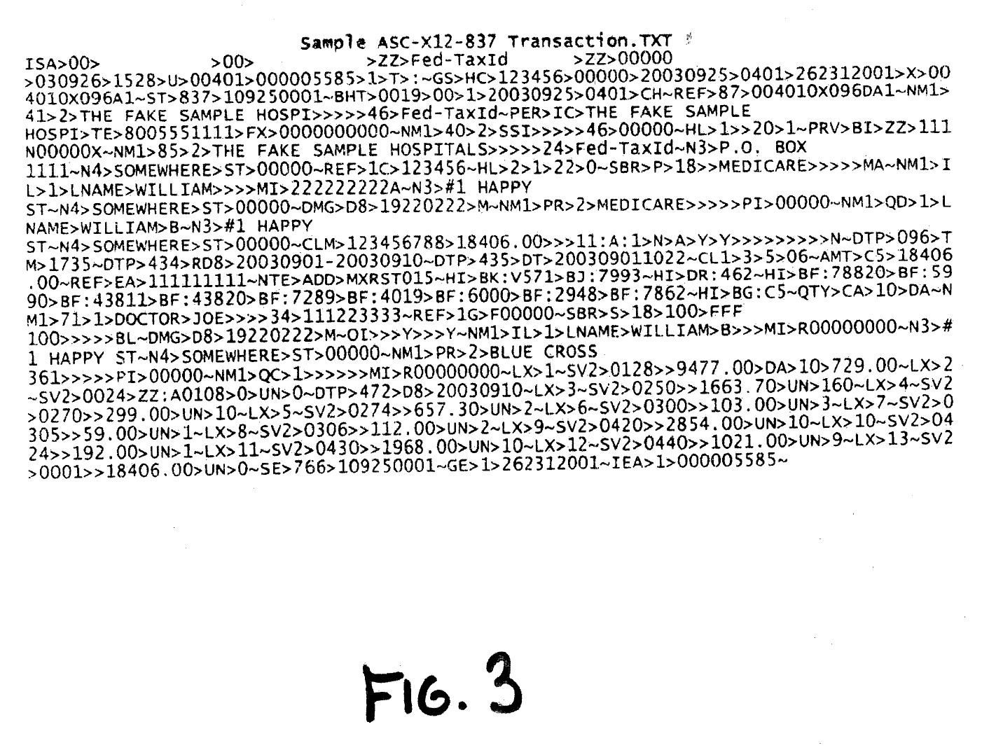

Referring now to FIG. 2, there is shown an overview of operational steps in flow diagram form, of an embodiment of a method of the invention for processing transaction records concerning financial reimbursement claim information communicated between two entities.

Act 205:—Data collection—a claims submission process is initiated by the health care provider 22 by sending EDI batch claim submissions (i.e., a group of healthcare claims) to the health care payer 12 as transaction data 50 in a first data format corresponding to the American National Standards Institute (ANSI) ASC X12 837 data format. In alternate embodiments, the first data format could also represent an extensible markup language (XML) compatible format or a standard generalized markup language (SGML) compatible data format or an ANSI ASC X12 835 data format (a remittance claim) or an ANSI ASC X12 272 data format (a property and casualty loss notification). It is noted that in the presently described embodiment, the EDI batch claim transaction data 50 is associated with either particular patients or a particular user accessing records.

Concurrent with the act of sending the batch claim transaction data 50 to the health care payer 12 from the health care provider 22, the batch claim transaction data 50 is archived in the system of the invention for future reference. This latter process defines the operational steps of the invention. It is noted that a health care provider 22 such as a hospital would archive the batch claim transaction data 50 for the purpose of seeing what claims they have sent to the health care payer 12.

In operation, the operational steps that define the invention, namely, the archiving of batch claim transaction data 50, is performed as follows, in accordance with an embodiment of the invention.

With continued reference to FIG. 1, the EDI batch claim transaction data 50 in the first data format (e.g., the standard ANSI X12 837 data format) is sent to the health care payer 12 and concurrently sent to the interface processor 20 of the system of the invention. As shown in FIG. 1, the system of the invention is co-located with the health care provider 22.

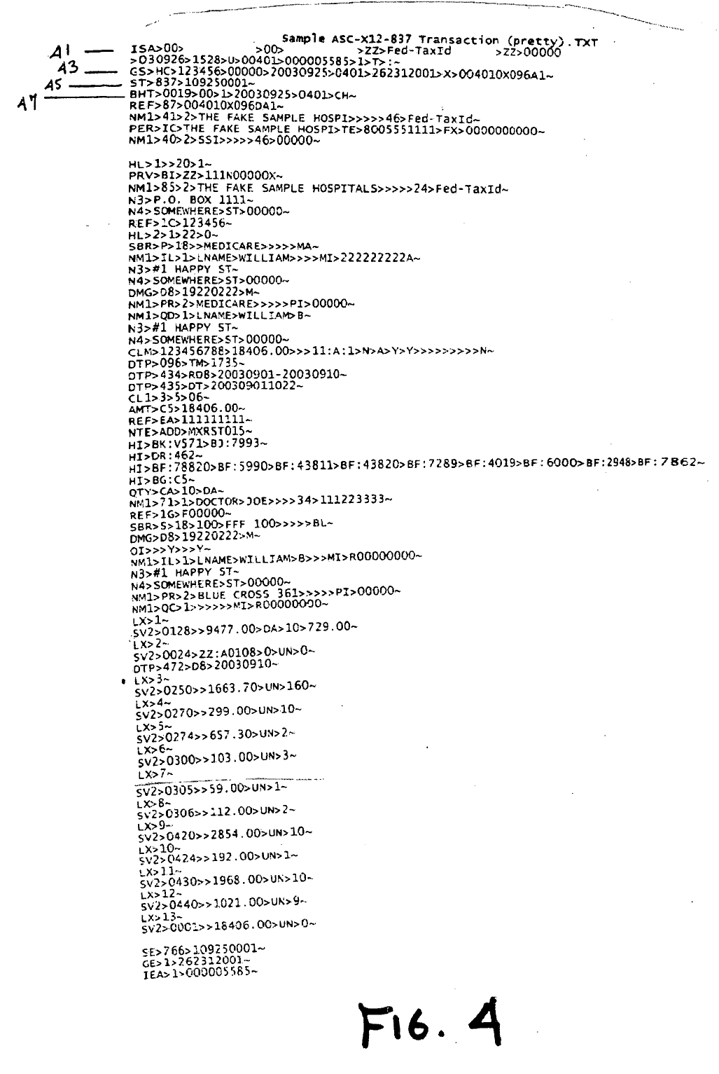

FIG. 3 is an exemplary listing of EDI batch claim transaction data 50 submitted by a health care provider 22, formatted in accordance with the standard ANSI X12 837 data format (i.e., data in the first data format). As shown in FIG. 3, the ANSI X12 837 batch claim transaction data listing comprises a long stream of ASCII data with delimeters embedded within. As is obvious from the listing shown, the format is not easily read or understood by humans.

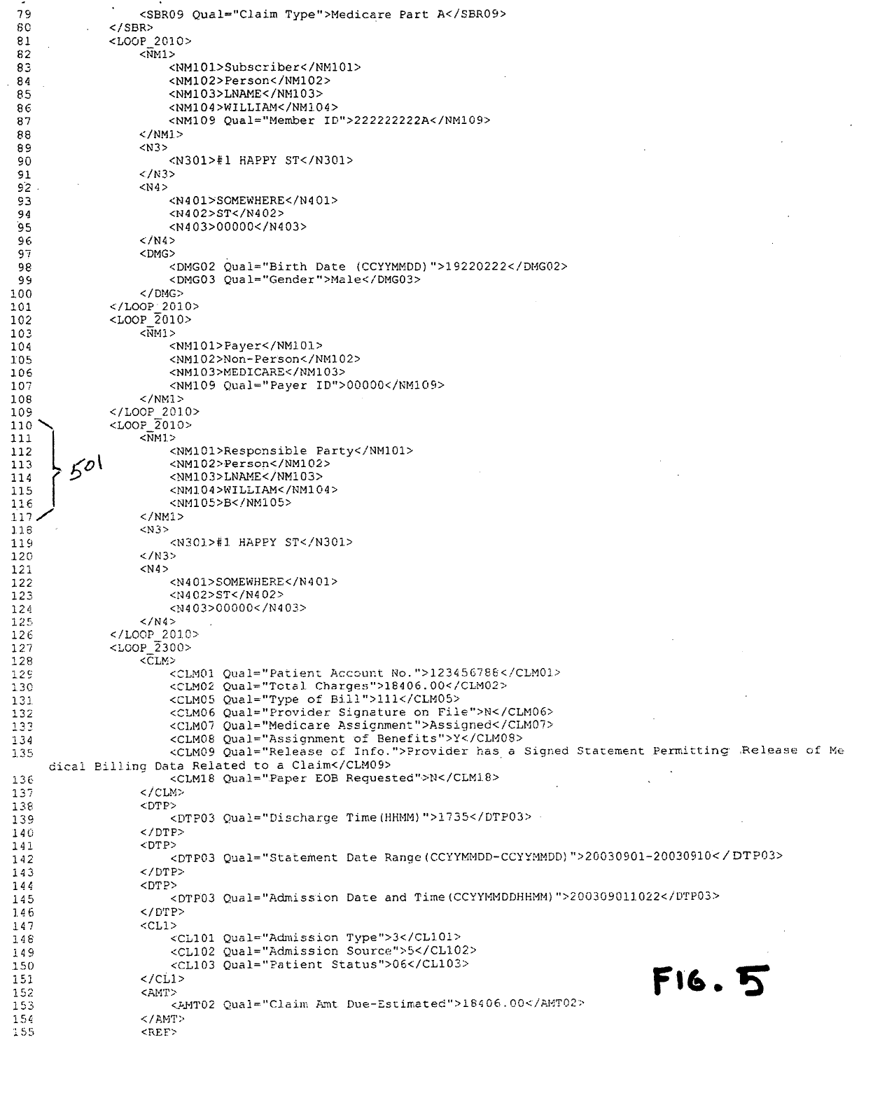

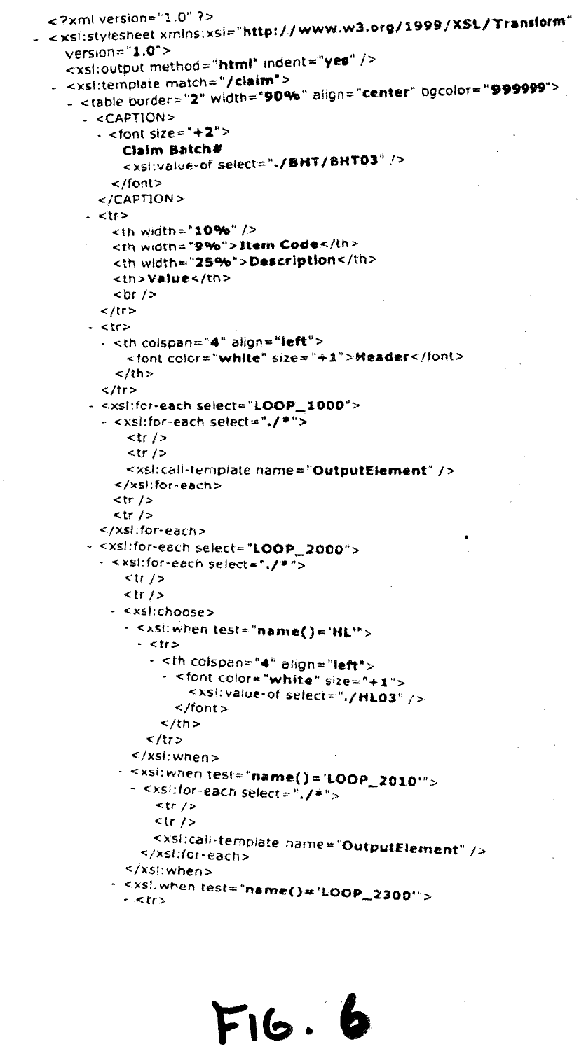

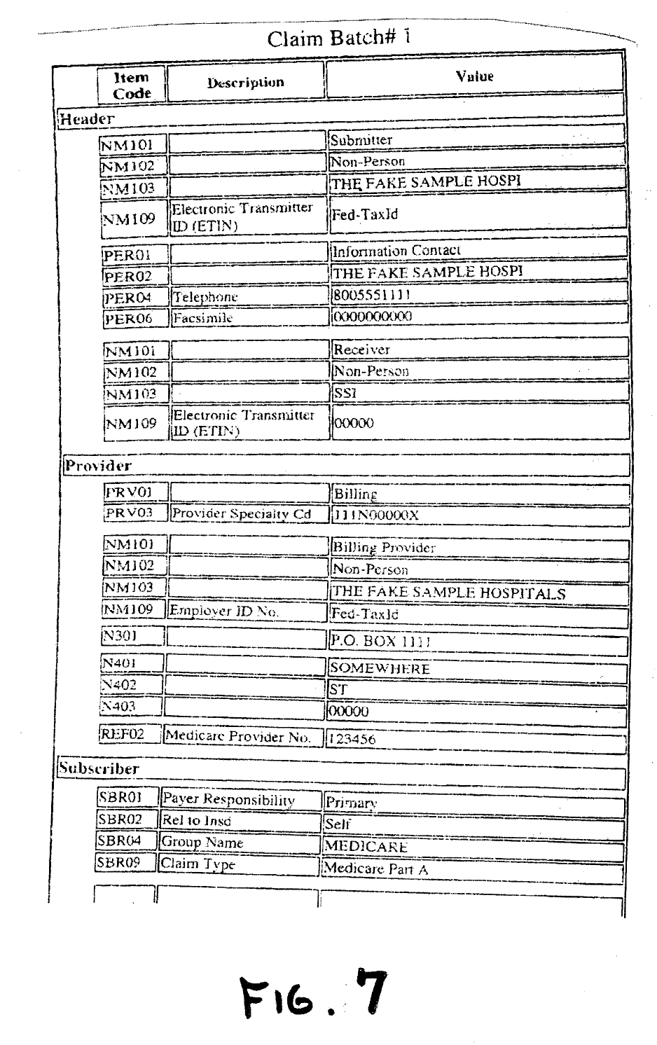

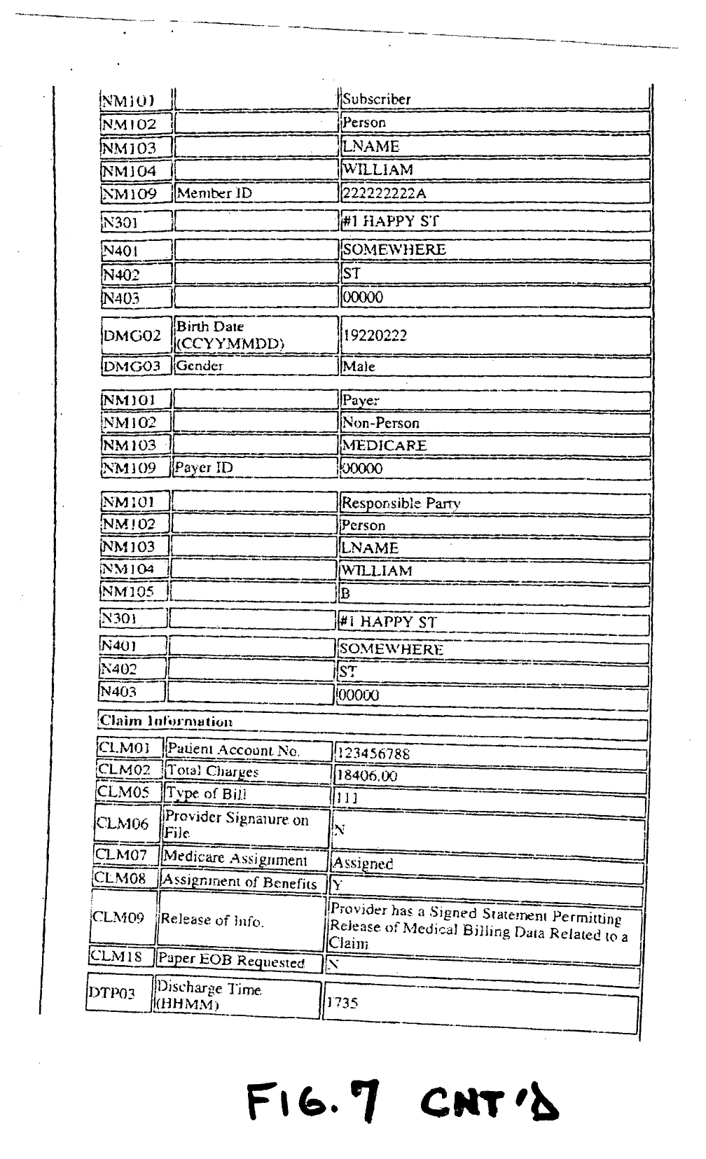

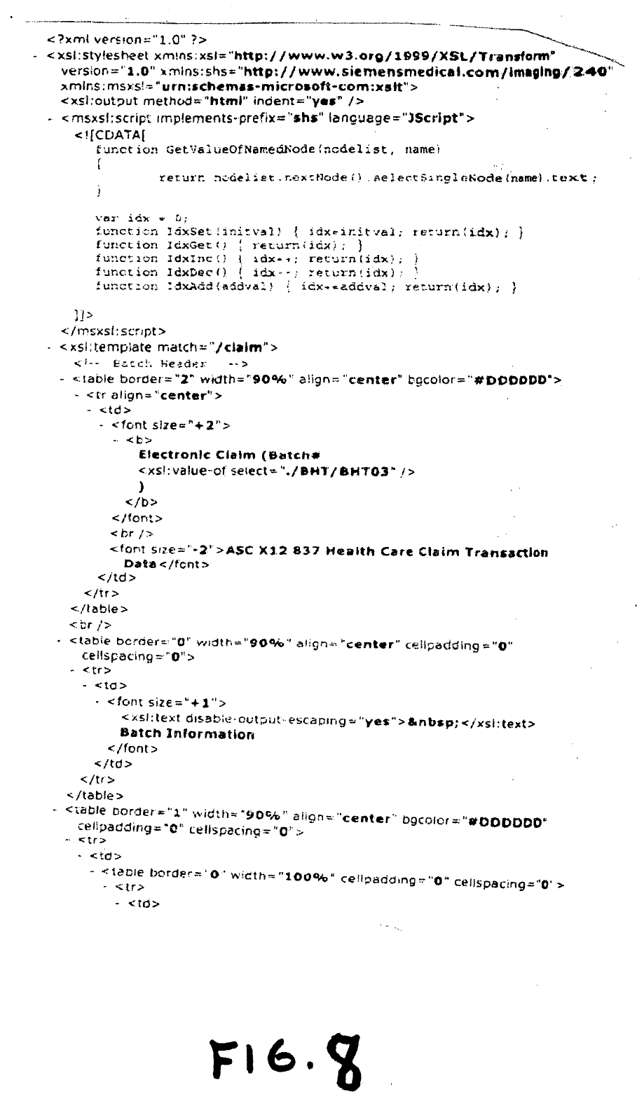

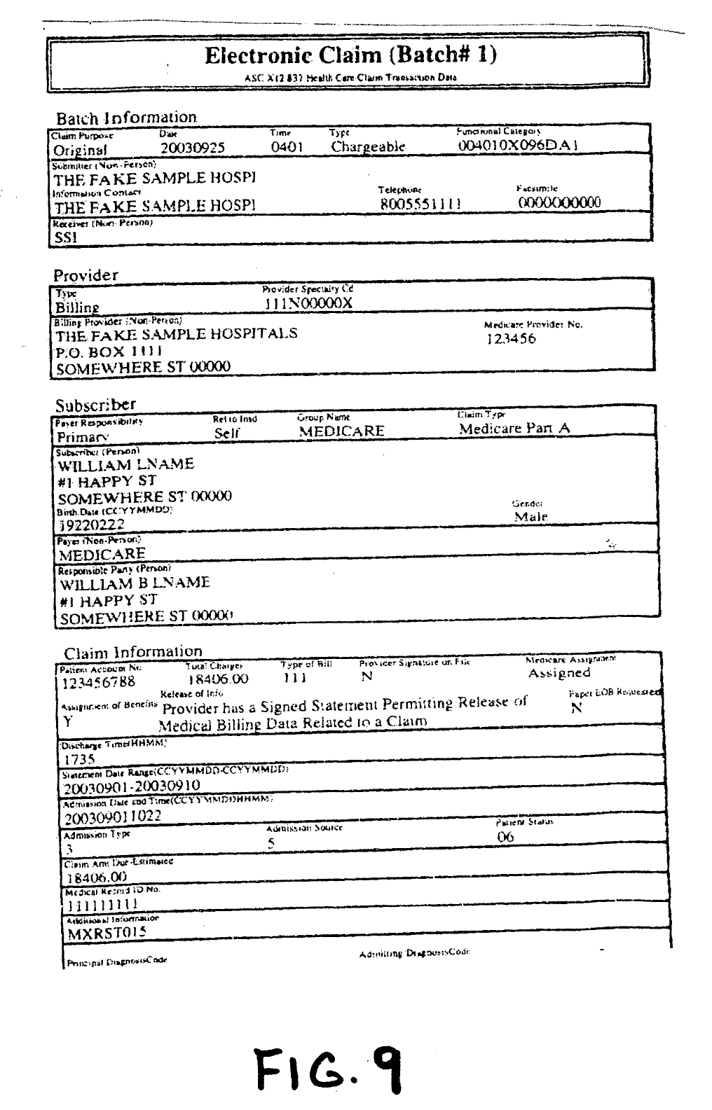

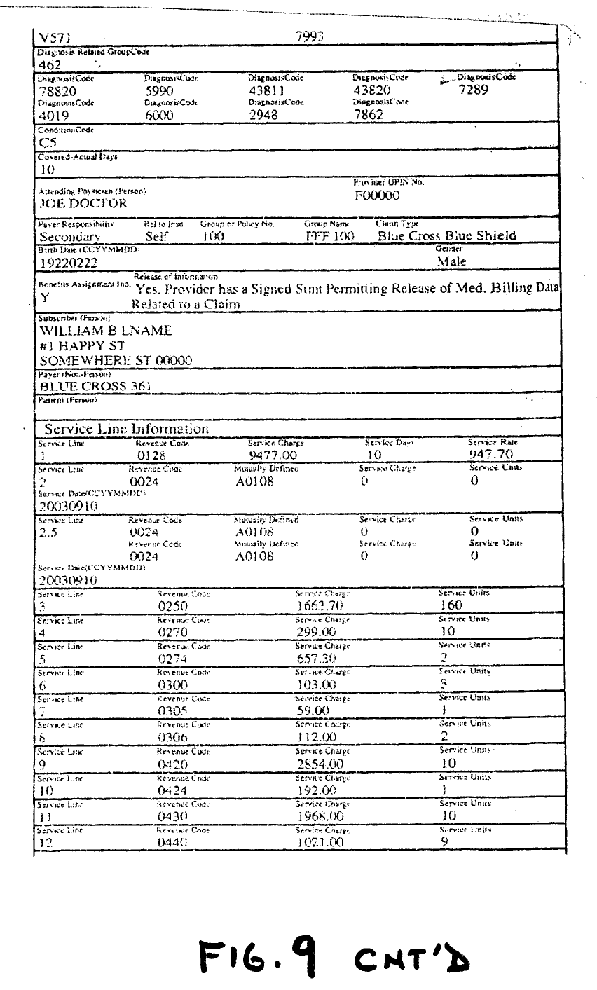

FIG. 4 is a more readable representation of the listing of FIG. 3 for purposes of understanding the instant invention. It is to be understood, however, that the batch claim transaction data 50 shown in FIG. 4 is for illustrative purposes, and does not reflect the batch claim data format transmitted from the health care provider. As is conventional and more apparent from the batch claim transaction data listing of FIG. 4, the ANSI X12 837 batch claim transaction data is comprised of a number of named segments (e.g., ISA 41, GS 43, ST 45, BHT 47), where the named segment are comprised of one or more components. For example, the first data segment, ISA 41 is comprised of a single component, i.e., “00”. The next segment, GS 43, is shown to be comprised of eight components, i.e., “HC”, “123456”, “00000” and so on.

Act 210 (FIG. 2):—Transformation—The data 50 received by the interface processor 20 in the first data format is output from the interface processor 20 and supplied as input to the transformation processor 22 which converts (maps) the received EDI batch claim transaction data 50 from the first data format to a more generic and easily processed second data format 55.

In the present exemplary embodiment, the second, more generic and easily processed, second data format 55, output from the transform processor 22, is the extensible markup language (XML) data format. XML is a preferred data format because it is a universally usable language for data on the Web. A well known feature of XML is that a tag is defined by the XML itself. That is, the tag conveys the meaning of the content of the tag. Further, XML allows the creation of unique data formats to allow greater flexibility for the purpose of allowing customization. The ability to create an unlimited number of unique tags in XML, particular to the needs of an application, allows this flexibility. XML is also desirable in that it provides a good way to store information because it can be easily read and understood by humans and machines. XML has the advantage that it describes the content of the data, rather than how it should look. The conversion or mapping of the transaction data from the first data format 50, i.e., the ANSI ASC X12 837 data format, to the re-formatted second data format 55, i.e., the XML data format, involves mapping the named segments of the transaction data from the first data format to the re-formatted second data format. In the illustrative embodiment, the non-named segments are ignored or dropped during the format conversion process.

Act 215:—Indexing—FIG. 5 is an illustration of the re-formatted received transaction information 55 in the second data format (i.e., the XML data format). The re-formatted received transaction identification information 55 is supplied to the indexing processor 24 which extracts index information 60 from the individual records which comprise the re-formatted received transaction identification information 55 in the second data format. Indexing is a necessary operation to provide a future capability for retrieving the re-formatted received transaction information 55 once it is archived (stored) in the data repository 28. The index information 60 is extracted from the records using tags of the XML transaction data. It is noted that, in general, the indexing processor 24 adaptively applies different extraction methods based on the document type of the reformatted transaction data 55.

In accordance with the exemplary application, the XML tags of the re-formatted received transaction information 55 are used as index information for the purpose of identifying and extracting the re-formatted received transaction information 55 after it has been stored in data repository 28. In the exemplary application, the XML tags correspond to predetermined information for identifying and extracting index information about a patient such as the patient's first name, last name, birth-date, medical record identifier, an account identifier, a patient hospital registration related identifier, a healthcare payer organization identifier, a healthcare provider organization identifier, a visit identifier, an encounter identifier and a case identifier.

A specific example of how the XML tags correspond to predetermined information about a patient is illustrated in Loop 2010 at lines 110 through 117 of FIG. 5, generally labeled as 501. Loop 2010 includes some representative XML tag identifiers (tag identifiers NM101 through NM 105) which correspond to predetermined information about a patient. For example, tag NM101 describes a “responsible party” affiliated with the patient, tag NM102 describes the “person”, tag NM103 describes a patient's last name, “LNAME”, tag NM104 describes a patient's first name and tag 105 describes a patient's middle initial.

Act 220:—Storage—At this stage, the re-formatted received transaction information 55, in the XML data format, is burst into individual patient documents 58 by a bursting processor 27 and stored, in either compressed or uncompressed form, under the control of the storage processor 29 in data repository 28 along with the extracted index information 60 for use in identifying the re-formatted received transaction information 55. The data repository 28 forms a part of a document management system of the health care provider 22.

Act 225:—Display—The re-formatted transaction data may be displayed to a user on display processor 26 in response to a user command. For purposes of display, an XSLT style sheet is applied to the re-formatted transaction data 55 by the display processor 26.

FIG. 6 illustrates an exemplary style sheet syntax that may be applied to the re-formatted transaction data 55 to create a Hypertext Markup Language (HTML) document for use by a browser. In general, the reformatted transaction data 55 in the second data format may be transformed for different delivery platforms by using different XSLT stylesheets.

FIG. 7 is the display that results when the style sheet syntax shown in FIG. 6 is applied to the re-formatted transaction data 55 of FIG. 5 and executed by display processor 26.

FIG. 8 is a further example of a different XSLT style sheet that may be applied to the XML formatted data 55 of FIG. 5 providing a resulting display format as shown in FIG. 9. As shown in FIG. 9, the display format groups transaction identification information into various categories including batch information, provider information, subscriber information and financial claim information.

The advantageous display formats provided in FIGS. 7 and 9 provide consistency in transaction identification information.

Although this invention has been described with reference to particular embodiments, it should be appreciated that many variations can be resorted to without departing from the spirit and scope of this invention as set forth in the appended claims. The specification and drawings are accordingly to be regarded in an illustrative manner and are not intended to limit the scope of the appended claims.

1. A system for processing transaction records concerning financial reimbursement claim information communicated between two entities, comprising:
an interface processor for receiving information in a first data format identifying transactions concerning financial reimbursement claim information communicated between two entities;
a transformation processor for converting said received transaction identification information having said first data format to a different second data format;
an indexing processor using predetermined information concerning said different second data format to identify and extract index information from said re-formatted received transaction identification information; and
a display processor for initiating display of said re-formatted received transaction identification information in response to user command.

2. A system according to claim 1, including
a storage processor for storing a record representing said re-formatted received transaction identification information and associated extracted index information in at least one repository.

3. A system according to claim 1, wherein
an entity comprises at least one of (a) a hospital, (b) a physician group, (c) a clinic, (d) a healthcare reimbursement claim payer institution, (e) a healthcare provider institution, and (f) a hospital department.

4. A system according to claim 1, including
a storage processor for storing said re-formatted received transaction identification information and associated extracted index information in at least one repository.

5. A system according to claim 1, including
a storage processor for storing said re-formatted received transaction identification information in a file associated with said extracted index information.

6. A system according to claim 1, wherein
said different second data format is at least one of, (a) an Extensible Markup Language (XML) compatible format, (b) an (Standard Generalized Markup Language) SGML compatible format and (c) (American National Standards Institute Electronic Data Interchange) ANSI 272 compatible format and
said predetermined information concerning said different second data format used to identify and extract index information from said re-formatted received transaction identification information includes XML compatible tag identifiers.

7. A system according to claim 1, wherein
said first data format is at least one of, (a) an (American National Standards Institute) ANSI 837 compatible format, (b) (American National Standards Institute Electronic Data Interchange) ANSI 835 compatible format (c) (American National Standards Institute Electronic Data Interchange) ANSI 272 compatible format (d) an (American National Standards Institute Electronic Data Interchange) ANSI 272 compatible format SGML compatible format.

8. A system according to claim 1, wherein
said information in said first data format identifying transactions concerning financial reimbursement claim information comprises information identifying a data exchange between said two entities.

9. A system according to claim 1, wherein
said information in said first data format identifying transactions concerning financial reimbursement claim information comprises information identifying a data exchange between said two entities.

10. A system according to claim 1, wherein
said interface processor parses said received information in said first data format to identify records representing individual transactions;
said transformation processor converts said records representing individual received transaction information into said different second data format, and
said indexing processor uses said predetermined information concerning said different second data format to identify and extract index information from said re-formatted individual received transaction information.

11. A system according to claim 1, wherein
said display processor initiates processing said re-formatted received transaction identification information to be suitable for at least one of, (a) Fascimile transmission, (b) printing (c) export to a recipient system, in response to user command and (d) display.

12. A system according to claim 1, including
a storage processor for compressing and storing said re-formatted received transaction identification information in at least one repository, by eliminating redundant information from said re-formatted received transaction identification information.

13. A system according to claim 1, wherein
said extracted index information comprises at least one of, (a) a patient identifier, (b) a Medical Record identifier, (c) an account identifier, (d) a patient hospital registration related identifier, (e) a Healthcare payer organization identifier, (f) a healthcare provider organization identifier, (g) a visit identifier, (h) an encounter identifier and (i) a case identifier

14. A system according to claim 1, wherein
said extracted index information is identified based on XML compatible tag delimited data fields.

15. A system according to claim 1, wherein
said indexing processor adaptively applies different extraction methods based on a document type of said re-formatted received transaction identification information.

16. A system according to claim 1, including
a bursting processor for separating said re-formatted received transaction identification information into separate documents for storage in a file associated with corresponding different patients.

17. A system according to claim 1, wherein
said extracted index information is used for associating said received transaction identification information with an existing record.

18. A system according to claim 1, wherein
said re-formatted received transaction identification information identifies transactions associated with at least one of, (a) a particular patient and (b) a particular user accessing records.

19. A method for processing transaction records concerning financial reimbursement claim information communicated between two entities, comprising the activities:
receiving information in a first data format identifying transactions concerning financial reimbursement claim information communicated between two entities;
converting said received transaction identification information having said first data format to a different second data format;
indexing said re-formatted received transaction identification information of said different second data format to identify and extract index information, said extracted index information being used for associating said received transaction identification information with an existing record; and
initiating display of said re-formatted received transaction identification information in response to user command.

20. A system for processing transaction records concerning financial reimbursement claim information communicated between two entities, comprising:
an interface processor for receiving information in an ANSI 837 compatible data format identifying transactions concerning financial reimbursement claim information communicated between two entities;
an indexing processor using predetermined information concerning said ANSI 837 compatible data format to identify and extract index information from said re-formatted received transaction identification information, said extracted index information is used for associating said received transaction identification information with an existing record; and
a display processor for initiating display of said received transaction identification information in response to user command.

21. A system for processing transaction records concerning financial reimbursement claim information communicated between two entities, comprising:
an interface processor for receiving information in a first data format identifying transactions concerning financial reimbursement claim information communicated between two entities;
an indexing processor for converting said received transaction identification information having said first data format to a different second data format; and
a display processor for initiating execution of a display format procedure for processing said re-formatted received transaction identification information to provide a desired display format, in response to user command.

22. A system according to claim 21, wherein
said first data format is at least one of, (a) an (American National Standards Institute) ANSI 837 compatible format, (b) (American National Standards Institute Electronic Data Interchange) ANSI 835 compatible format (c) (American National Standards Institute Electronic Data Interchange) ANSI 272 compatible format (d) a (Standard Generalized Markup Language) SGML compatible format.

23. A system according to claim 21, wherein
said desired display format consistently displays said re-formatted transaction identification information in a predetermined display data format.

24. A system according to claim 23, wherein
said desired display format groups transaction identification information into categories including at least one of, (a) (batch) transaction identification header information, (b) provider information, (c) subscriber information and (d) financial claim information.
